(19) United States
(12) Patent Application Publication
(10) Pub. No.: US 2018/0258582 A1
(43) Pub. Date: Sep. 13, 2018

(54) FIBERFILL HAVING COOLING EFFECT AND ARTICLES MADE THEROF

(71) Applicant: INVISTA NORTH AMERICA S.A.R.L., WILMINGTON, DE (US)

(72) Inventor: Don M. SALISBURY, Cartersville, GA (US)

(73) Assignee: INVISTA NORTH AMERICA S.A R.L., WILMINGTON, DE (US)

(21) Appl. No.: 15/559,685

(22) PCT Filed: Mar. 18, 2016
(86) PCT No.: PCT/US2016/023162

§ 371 Date: Sep. 19, 2017

Related U.S. Application Data
(60) Provisional application No. 62/136,461, filed on Mar. 21, 2015.

(51) Int. Cl. D06M 15/643; D02J 3/18; A47G 9/02; A47G 9/10; A47C 21/04; G01J 5/10; A63H 3/02; A63H 9/00

(52) U.S. Cl. CPC D06M 15/643; D02J 3/18; A47G 9/0215; A47G 9/1036; A47C 21/046; G01J 5/10; D06M 2101/32; A63H 9/00; D10B 2331/04; D10B 2503/06; D10B 2501/00; D10B 2401/022; A63H 3/02

(57) ABSTRACT

A fiberfill that provides a cooling effect, comprising a synthetic filament at least partially coated with a polymeric treatment, wherein the polymeric treatment comprises at least one hydrophilic finish disposed on the synthetic filament.

### TECHNICAL FIELD

The present disclosure generally relates to a synthetic fiberfill and, in particular, to polyester fiberfill having a cooling effect.

### BACKGROUND

The human body releases heat in a number of ways to help regulate its temperature. An important way of releasing heat to control body temperature is through releasing moisture. The human body can release anywhere from 0.5 liter of moisture to 8 liters per day depending on the individual and their level of activity. Moisture may be released through various mechanisms, such as breathing, bodily waste functions, and perspiration.

Perspiration may occur when the body tries to rid itself of enough heat (i.e., cool itself) that it employs the help of convective heat transfer and starts to sweat. How much the body perspires depends upon a number of factors, such as the temperature and air movement within the surrounding environment, a person's metabolic state, and the amount of heat trapping and moisture retaining material near the body. However, moisture produced by the body during perspiration can collect in clothing, bedding, and other materials kept close to the body, which can cause discomfort and/or impede the cooling process.

To reduce the discomfort caused by perspiration and to assist cooling the body, manufacturers have produced materials that generate a cooling effect. Typically, the cooling effect is generated using one of two common mechanisms. The first mechanism includes the use of phase change materials (PCMs). PCMs rapidly absorb heat to undergo a phase change at skin temperature and produce a sensation of cooling as a result. How well and how quickly PCMs work to provide the desired cooling may depend upon the amount of PCM material used and the melting temperature of the PCM since solid to liquid phase changes generally allow more heat to be captured than other types of phase changes. In this way, PCMs act as heat reservoirs that can only capture so much heat before the heat needs to be transferred away for the PCM to continue cooling. In addition, encapsulated PCM on fabric often last a few minutes and then cannot trap more heat into the reservoir. Accordingly, PCMs are generally more effective when used during dynamic activities, such as skiing, running, biking, etc.

For example, body heat generated during a physical activity, such as skiing, may be absorbed by PCMs in the skier's gloves. When traveling back up the ski lift, the skier's hands may start to cool with the help of the breeze from being on the lift, but heat trapped in the PCMs may nonetheless keep your hands relatively warm for at least a period of time. However, the applicability PCMs in bedding materials to provide a cooling effect is limited since normal sleeping conditions may not include conditions suitable for carrying heat away from the PCMs.

The other mechanism for reducing discomfort may include the use of a fabric that wicks away moisture. Hydrophilic finishes have been used for fabric effects to wick away moisture. For example, non-silicone finishes that have some slickness have been used in fiberfill and can be hydrophilic. However, non-silicone finishes have been used for situations that require better flame retardant properties for example. Hydrophilic slick finishes have not been used in fiberfill for the purpose of assisting comfort and cooling effects. Because hydrophilic finishes are not as slick as the wash and wear durable amino-silicone-based or silicone-based finishes there was a need to improve upon the slickness, “hand” and wear durability of the hydrophilic finish. Because silicones and polyester are quite hydrophobic there is also often a compatibility problem with mixtures of the two.

One attempt to improve the moisture wicking and cooling properties of a fabric is discussed in U.S. Pat. No. 5,088,140, which issued to Belcher et al. on Feb. 18, 1992 (the '140 patent). The '140 patent disclosed a method for etching the surface of a fiber to impart moisture wicking and absorption properties through a caustic treatment. The caustic treatment may allow the fibers to generate an apparent “cool” feel by wicking warm moisture away from the body. This invention is applicable to non-siliconized fiber whereas silicone-treated fiberfill is highly hydrophobic. For improved slick hand this treated fiber may be blended with 75% or less of siliconized fiberfill. However, the method of the '140 patent may be costly to use in manufacturing, require stainless steel process surfaces, and handling of the caustic finish mix.

Another attempt to improve a cooling property of a fabric is discussed in U.S. Pat. No. 6,371,977, which issued to Bumbarger et al. on Apr. 16, 2002 (the '977 patent). The '977 patent discusses a composite of layered materials that provided moisture retention and certain functionality to various apparel type end-uses. The composite undergoes a soaking process, and fluid retained in the composite evaporates through a retaining layer to provide a cooling effect. However, the composite of the '977 patent may be complex and include a waterproof layer and a saturated layer between the wearer and the air, which may decrease evaporation of perspiration and reduce the cooling effect.

### SUMMARY

Certain embodiments of the present disclosure relate to a polyester (PET) fiberfill having a polymeric surface treatment that imparts rapid wicking of moisture to produce a cooling effect. Other embodiments of the present disclosure relate to a fiberfill comprising other fibers in addition to or in place of the PET fibers. The disclosed fiberfill may be used with a variety of diverse products including finished bedding articles such as pillows, mattress pads, comforters, duvets, quilts etc.; furniture components, such as seat cushions and chair backings; stuffing for toys; sleeping bags; animal blankets; and other apparel articles that have a non-woven or high-loft non-woven applications, and embodiments of the present disclosure are directed to these articles. The disclosed surface treatment may include a hydrophilic composition for wicking away fluids, and a semi-slick mixture that may improve the hand and wear durability as compared to dry, untreated fiberfill. The disclosed fiberfill may also have a good wash durability through high temperature curing (e.g., greater than 130° F.) of the fiber.

Further embodiments of the present disclosure also relate to a method of evaluating the temperature differences of this polymeric surface treatment on synthetic fiberfill compared with common slick fiberfill as it relates to pillows and pads.

Additional embodiments of the present disclosure also relate to a method of making products that have been treated to impart a cooling effect on or near the skin of a person or animal that perspires.

Certain embodiments of the present disclosure are directed to a fiberfill that provides a cooling effect, comprising a synthetic filament at least partially coated with a polymeric treatment, wherein the polymeric treatment comprises at least one hydrophilic finish disposed on the synthetic filament.

Additional embodiments are directed to a method of forming a fiberfill that provides a cooling effect, comprising: moving a synthetic filament tow in an axial direction; and applying a polymeric treatment to the moving synthetic filament tow, wherein the polymeric treatment includes at hydrophilic finish.

Additional embodiments are directed to a method of measuring a cooling effect of a fiberfill, comprising: placing a droplet of water on the fiberfill; covering the droplet with an infrared transparent cover; and measuring a temperature using an infrared imaging device.

### BRIEF DESCRIPTION OF THE DRAWINGS

FIGS. 1a-3 show test methods according to the present disclosure for determining the temperature of articles from the fiberfill of embodiments of the present invention.

FIG. 4 is a chart showing the time and temperature curve of an article filled with fiberfill of embodiments of the present invention and a comparative example.

### DETAILED DESCRIPTION

The present disclosure relates to a fiberfill that provides a cooling effect, methods of making the fiberfill, articles at least partially filled with the fiberfill and methods of measuring the cooling effect in the articles.

In one nonlimiting embodiment of the disclosure, a fiberfill is disclosed that provides a cooling effect, wherein the fiberfill is at least partially coated with a polymeric treatment, wherein the polymeric treatment comprises at least one hydrophilic finish disposed on the fiberfill.

The fiberfill of the present disclosure can comprise a variety of fibers. Nonlimiting examples of such fibers include fibers that may be made from polyesters, including polyethylene terephthalate, polytrimethylene terephthalate, polybutylene terephthalate, polyethylene naphthalate, polylactic acid (PLA) and blends or copolymers thereof. In one embodiment, the fibers may be made of polyethylene terephthalate. In other embodiments, the fibers may be made of polyamides, including nylon 5,6; nylon 6/6; nylon 6; nylon 7; nylon 11; nylon 12; nylon 6/10; nylon 6/12; nylon DT; nylon 6T; nylon 61; and blends or copolymers thereof. In further embodiments, the fibers may be made of polyolefins, including polyethylene or polypropylene. In even further embodiments, the fiberfill comprises a mixture of the fibers disclosed herein. In one nonlimiting embodiment, the fiberfill is made from polyethylene terephthalate.

The fibers in accordance with the present disclosure can have dpf values ranging from 0.5 dpf to 40 dpf. Non-limiting examples include dpf values ranging from 0.5 dpf to 30 dpf, from 0.5 dpf to 20 dpf, from 0.5 dpf to 10 dpf, from 0.5 dpf to 5 dpf, from 0.5 dpf to 2 dpf, from 0.5 dpf to 1.5 dpf, from 1 dpf to 10 dpf, from 1 dpf to 5 dpf, from 5 dpf to 30 dpf, from 5 dpf to 20 dpf, from 5 dpf to from 10 dpf, and from 5 dpf to 7 dpf. In certain embodiments, the fibers can dpf values of less than 10 dpf, such as less than 7 dpf, less than 5 dpf, less than 3 dpf, and less than 1.5 dpf.

The fiberfill may have any crimp shape suitable for use in finished bedding articles such as pillows, mattress pads, comforters, duvets, quilts etc.; furniture components, such as seat cushions and chair backings; stuffing for toys; sleeping bags; animal blankets; and other apparel articles that have a non-woven or high-loft non-woven applications. Suitable crimp shapes include (1) mechanical crimp (i.e., a saw-tooth crimp), (2) a spiral conjugate, and (3) an omega conjugate (i.e., asymmetric or jet quench). In one nonlimiting embodiment, the fiberfill is mechanically crimped. In another nonlimiting embodiment, the fiberfill has a conjugate crimp.

Suitable polymeric treatments may include hydrophilic compounds known by those skilled in the art to impart hydrophilic properties to synthetic fibers. Suitable hydrophilic compounds include one or more of the following compounds supplied by Takemoto Finish and Oil Co.: Polymer emulsion DELION 9515 or a combination of DELION 9462 and TWE-115.

In one nonlimiting embodiment, the hydrophilic finish comprises at least 40% by weight of the polymeric treatment. In other embodiments, the hydrophilic finish can comprise from 40 to 95% of polymeric treatment, such as from 50 to 95%, 60 to 95%, from 70 to 95%, from 80 to 95%, from 40 to 85%, 40 to 75%, from 40 to 65%, from 50 to 85%, and from 60 to 85%. In another nonlimiting embodiment, the hydrophilic finish comprises from 0.1 to 0.5% by weight of the fiberfill. For example, in other embodiments, the amount of hydrophilic finish, based on the weight of the fiberfill, can range from 0.01 to 1.0%, from 0.05 to 1.0%, from 0.1 to 1.0%, from 0.3 to 1.0%, from 0.5 to 1.0%, from 0.01 to 0.8%, from 0.01 to 0.6%, from 0.05 to 0.8%, from 0.05 to 0.6%, from 0.1 to 0.8%, from 0.1 to 0.6%, from 0.2 to 0.8%, from 0.1 to 0.5%, and from 0.3 to 0.5%.

In nonlimiting embodiments, the polymeric treatment further comprises a silicone compound disposed on the fiberfill. Suitable silicone compounds include silicone, an amino-silicone, an amino-siloxane or combinations thereof. In one nonlimiting embodiment, the silicone compound is an amino-siloxane. Other suitable silicone compounds include one or more of the following compounds supplied by Takemoto Finish and Oil Co.: DELION 4149, DELION 4239 or DELION 4146,

Any or a mixture of these components may be applied to tow 14 to form a durable slick hand when remaining solids of the mixture cover from about 0.4 to about 0.7% by weight of fiberfill 10. Second mixture 12 may additionally or alternatively comprise any suitable and/or commercially available silicone or amino-silicone.

In one nonlimiting embodiment, the silicone compound comprises at least 5% by weight of the polymeric treatment. In another nonlimiting embodiment, the silicone compound comprises at least 20% of the polymeric treatment. In other embodiments, the silicone compound can comprise from 5 to 60% of polymeric treatment, such as from 10 to 60%, from 15 to 60%, from 20 to 60%, from 5 to 50%, from 5 to 40%, from 5 to 30%, from 10 to 50%, from 10 to 40%, from 10 to 30%, from 15 to 40%, and from 15 to 30%. In another nonlimiting embodiment, the silicone compound comprises from about 0.1 to about 0.7% by weight of the fiberfill. For example, in other embodiments, the amount of silicone compound that remains on fiberfill 10, based on the weight of the fiberfill, can range from 0.01 to 1.0%, from 0.05 to 1.0%, from 0.1 to 1.0%, from 0.3 to 1.0%, from 0.5 to 1.0%, from 0.01 to 0.8%, from 0.05 to 0.8%, from 0.1 to 0.8%, from 0.3 to 0.8%, from 0.01 to 0.7%, from 0.05 to 0.7%, from 0.1 to 0.7%, from 0.2 to 0.7%, and from 0.3 to 0.7%.

In accordance with the present disclosure, the fiberfill disclosed herein may be used in a variety of diverse products, including both woven and non-woven products. Non-limiting examples of the products include: finished bedding products, such as pillows, duvets, quilts, and comforters; furniture components, such as seat cushions and chair backings; stuffing for toys; sleeping bags; animal blankets; and other apparel articles that have a non-woven or high-loft non-woven applications.

In one aspect of the current invention, articles are disclosed comprising the fiberfill disclosed herein.

In another aspect of the current invention articles are disclosed comprising fiberfill at least partially coated with a polymeric treatment, wherein the polymeric treatment comprises at least one hydrophilic finish disposed on the fiberfill. In nonlimiting embodiment, the polymeric treatment further comprises a silicone compound disposed on the fiberfill. Articles included in aspects of the current invention include finished bedding products, furniture components, stuffing for toys, sleeping bags and animal blankets.

In one nonlimiting embodiment, article is selected from consisting of pillows, mattress pads, comforters, duvets and quilts.

In another aspect of the current invention, an article is disclosed comprising at least two types of cooling-effect fiberfill comprising a first fiberfill at least partially coated with a polymeric treatment, wherein the polymeric treatment comprises at least one hydrophilic finish disposed on the fiberfill and a second fiberfill at least partially coated with a polymeric treatment, wherein the polymeric treatment comprises at least one hydrophilic finish disposed on the fiberfill and further comprises a silicone compound disposed on the fiberfill.

In another aspect of the current invention, an article is disclosed comprising at least two types of fiberfill comprising a first cooling-effect fiberfill at least partially coated with a polymeric treatment, wherein the polymeric treatment comprises at least one hydrophilic finish disposed on the fiberfill and a second fiberfill at least partially coated with a polymeric treatment, wherein the polymeric treatment comprises at least one silicone compound disposed on the fiberfill.

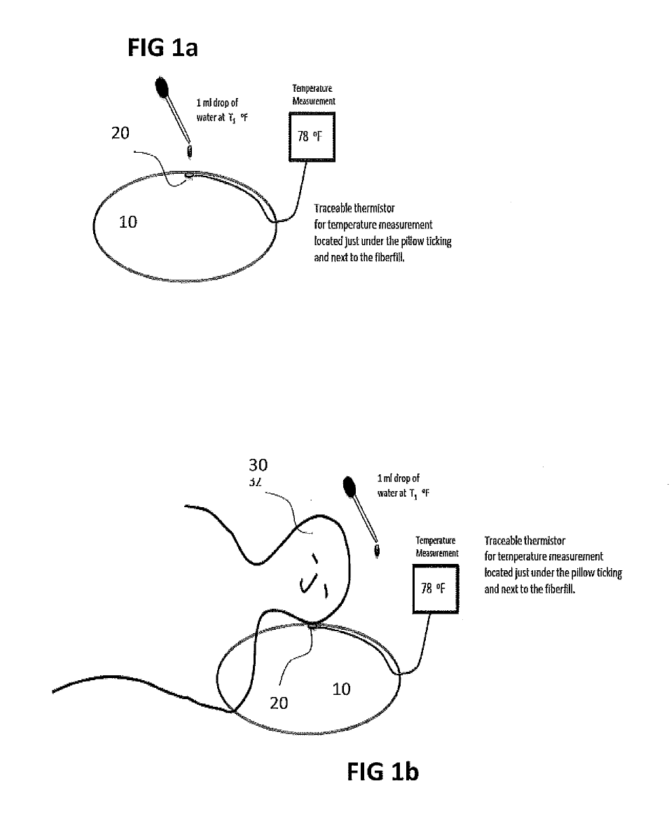

FIGS. 1a-3 show four exemplary methods that may be used to determine the cooling effect generated by the fiberfill of this disclosure. For example, FIG. 1a shows a first method that includes measuring the temperature of a small water droplet having a certain initial temperature T1 as it is applied to a bedding article, such as pillow 10. T1 may be range from 100 to 120° C. However, it is understood that T1 may be higher or lower, if desired. The first method may include imbedding a temperature probe 20, such as a thermistor, between the pillow tick and the fiberfill located at the center of pillow 10 when looking down upon it. Temperature probe 20 may indicate how the temperature inside pillow 20 changes as the water droplet permeates the pillow tick and the fiberfill.

FIG. 1b shows a second method that may be used to determine the cooling effect generated by fiberfill of this disclosure. The second method may include the same steps as the first method, and further include resting an object 30 on pillow 10 to simulate the weight of a head resting on pillow 10. Object 30 may be a dummy, a manikin, or another object configured to provide a similar downward force and cover the area of pillow 10 where the droplet of water is placed. In this way, second method may reduce evaporative effects of the water droplet to more realistically simulate a person lying on pillow 10. In one example, object 30 may be a 4-inch diameter thermal transparent glass cover having a ¼ to ½ inch edge that seals pillow 10 from the surrounding convective air. The edge the glass may also ensure that there is no disturbance of the water droplet though it is possible to actually have something resting on the surface after the droplet is put on the fabric or applied while a glass is already on the fabric.

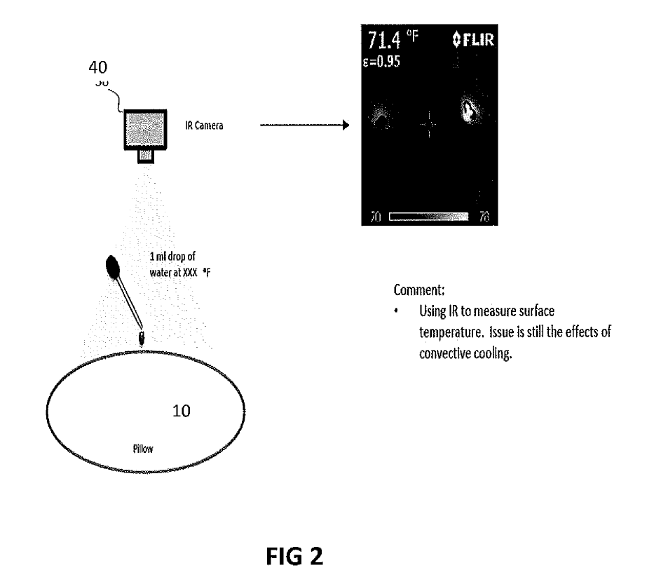

FIG. 2 shows a third method that may be used to determine the cooling effect generated by fiberfill of this disclosure. The third method may include the use of an infrared (IR) imaging device 40 instead of temperature probe 20. IR imaging device 40 may measures temperature in 2-dimensions (e.g., over a surface area). IR imaging device 40 may provide faster results than temperature probe 20, thereby reducing inaccuracies caused by thermal lag of temperature probe 20. Results may be compared with results gathered using a control material, such as common siliconized fiberfill, to provide a comparison of the cooling effect of fiberfill of this disclosure with other types of fiberfill.

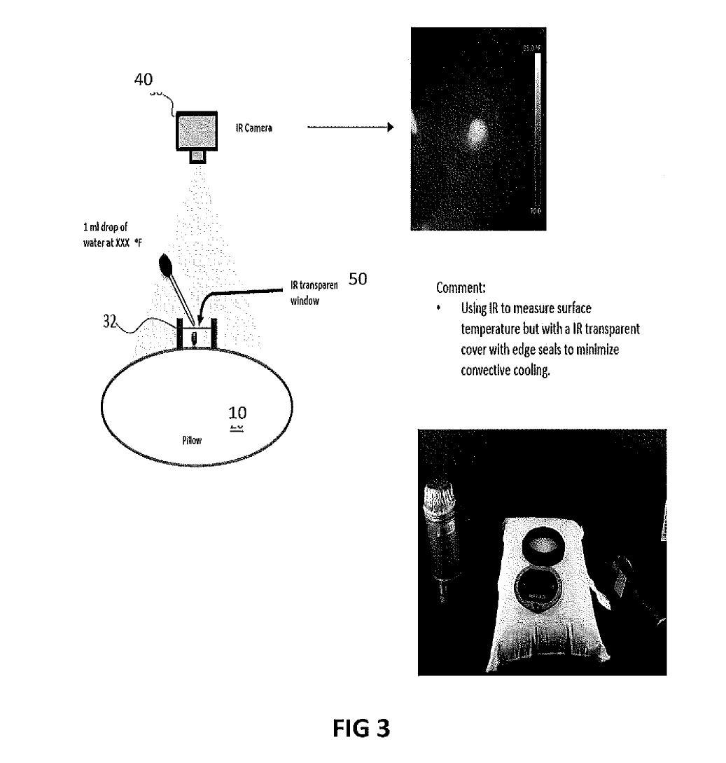

FIG. 3 shows a fourth method 40 that may be used to determine the cooling effect generated by fiberfill of this disclosure. Fourth method 40 may combination aspects of second and third methods, wherein object 30 may be used to minimize convective cooling for more realistically simulated temperature measurements. IR imaging device 40 may be used in combination with object 30 in fourth method to rapidly and accurately capture and view the temperature in 2-dimensions. In this method, object 30 may include a window 50 is made of infrared transparent material, thereby allowing for a more accurate measurement of temperature as compared to typical glass, which is less transparent to thermal radiation in the wavelengths of IR imaging device 40.

In another aspect of the current invention a method is disclosed for measuring a cooling effect of fiberfill in an article, comprising: a) measuring an intial temperature of the surface of the article at a first region using an infrared imaging device; b) placing a droplet of water on the surface of the article at the first region; and c) measuring the temperature at the surface of the article at the first region using an infrared imaging device at multiple time increments after step b is performed. In a nonlimiting embodiment the method further comprises comparing the temperatures measured in step c to the intial temperature measured in step a. In another nonlimiting embodiment, the method further comprises at least partially covering the droplet with an infrared transparent cover after placing a droplet of water on the surface of the article at the first region.

### EXAMPLES

### Example 1

Two pillows were made, each having the same fill weight and the same ticking cover of 100% cotton. Each pillow was treated with a polymeric treatment with one hydrophilic finish disposed on the fiberfill (compound A) or a polymeric treatment with one hydrophilic finish and one silicone compound disposed on the fiberfill (compound AB), and the control sample was made and treated with common siliconized fiberfill (compound B). All samples were evaluated at the same time.

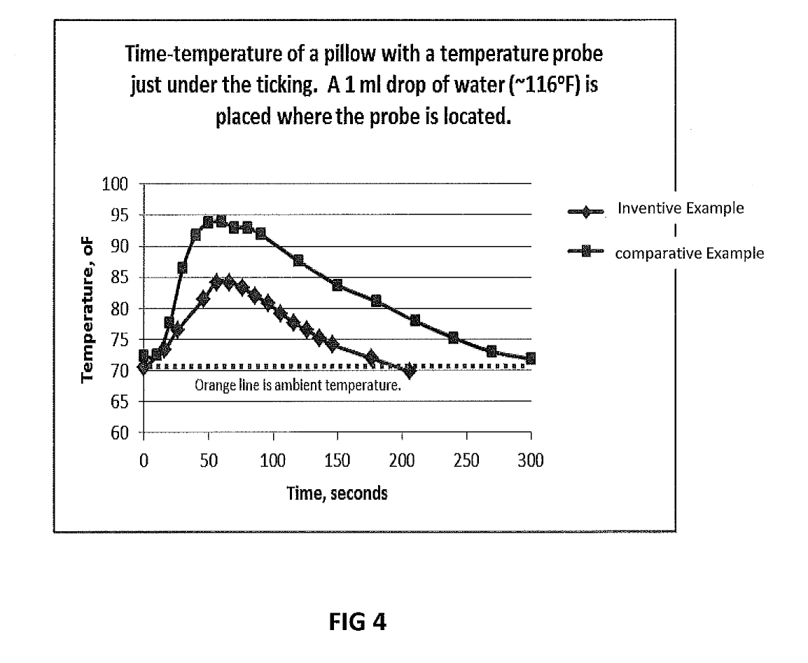

A temperature calibrated and traceable thermistor was placed between the cotton ticking and the fiberfill of each pillow. The probe was centered on the pillow looking down onto the pillow. A one milliliter drop of water with a temperature at T1 was placed upon the center of the pillow where the probe is located. The small amount of water was used to simulate some effect of sweating. This small amount of was chosen instead of a larger quantity of water to avoid distorting the scope of the experiment, which is to test the effects of cooling based on perspiration. The water at T1 was stored in an evacuated thermos and temperature taken just prior to placing a drop upon the pillow. Using a higher temperature water droplet may demonstrate the concept of “cooling” in a more exaggerated way than a temperature near body temperature. Temperature and time were recorded for each pillow. The test results indicated that there was a cooling effect experienced when compound AB and compound A were used versus when compound B (like the normal siliconized fiberfill) was used. The test results are summarized in FIG. 4.

### Example 2

To reduce the effects of convective cooling during the tests, experiments were redone with a cover over the droplet of water. A 4-inch diameter window was placed on top of the pillow and centered. The window had an edge to create a seal with the pillow and keep the window from touching the droplet of water. The glass window was made of infrared transparent material. The same steps as Example 1 were again carried out with the window placed over the water droplet for each sample. Time and temperature results were taken, and again the test results indicated that there was a cooling effect experienced when compound AB and compound A were used versus when compound B was used.

### Example 3

To reduce temperature lag and increase the accuracy of test results, Example 1 was repeated using an IR imaging device instead of a thermistor or other type of temperature probe. Thermistor's may also require additional time and energy to heat up, whereas IR devices may obtain accurate results more quickly and with a larger 2-dimensional view of the temperature in the area surround the water. Example 3 was carried out using the same steps as Example 1 but with the infrared imaging device used in place of the temperature probe.

### Example 4

To reduce the effects of convective forces that can rapidly cool the droplet of water, and to increase the accuracy of test results, Example 4 used the infrared transparent cover glass and infrared imaging device of Example 2 and Example 3, respectively. The same steps as Example 3 were used with the addition of the infrared transparent cover glass.

1. A fiberfill that provides a cooling effect, comprising:
fiberfill at least partially coated with a polymeric treatment, wherein the polymeric treatment comprises at least one hydrophilic finish disposed on the fiberfill.

2. The fiberfill of claim 1, wherein the polymeric treatment further comprises a silicone compound disposed on the fiberfill.

3. The fiberfill of claim 2, wherein the silicone compound includes an amino-siloxane.

4. The fiberfill of clam 1, wherein the hydrophilic finish comprises at least 40% by weight of the polymeric treatment.

5. The fiberfill of clam 2, wherein the silicone compound comprises at least 5% by weight of the polymeric treatment.

6. The fiberfill of clam 2, wherein the silicone compound comprises 20% of the polymeric treatment.

7. The fiberfill of clam 1, wherein the hydrophilic finish comprises from 0.1 to 0.5% by weight of the fiberfill.

8. The fiberfill of clam 2, wherein the silicone compound comprises from 0.1 to 0.7% by weight of the fiberfill.

9. The fiberfill of claim 1, wherein the fiberfill is formed from polyester.

10. An article comprising a cooling-effect fiberfill comprising:
fiberfill at least partially coated with a polymeric treatment, wherein the polymeric treatment comprises at least one hydrophilic finish disposed on the fiberfill.

11. The article of claim 10, wherein the polymeric treatment further comprises a silicone compound disposed on the fiberfill.

12. The article of claim 11, wherein the silicone compound includes an amino-siloxane.

13. The article of clam 10, wherein the hydrophilic finish comprises at least 40% by weight of the polymeric treatment.

14. The article of clam 11, wherein the silicone compound comprises at least 5% by weight of the polymeric treatment.

15. The article of clam 14, wherein the silicone compound comprises 20% of the polymeric treatment.

16. The article of clam 10, wherein the hydrophilic finish comprises from 0.1 to 0.5% by weight of the fiberfill.

17. The article of clam 11, wherein the silicone compound comprises from 0.1 to 0.7% by weight of the fiberfill.

18. An article comprising at least two types of cooling-effect fiberfill comprising:
a) a first fiberfill at least partially coated with a polymeric treatment, wherein the polymeric treatment comprises at least one hydrophilic finish disposed on the fiberfill; and
b) a second fiberfill at least partially coated with a polymeric treatment, wherein the polymeric treatment comprises at least one hydrophilic finish disposed on the fiberfill and further comprises a silicone compound disposed on the fiberfill.

19. An article comprising at least two types of fiberfill comprising:
a) a first cooling-effect fiberfill at least partially coated with a polymeric treatment, wherein the polymeric treatment comprises at least one hydrophilic finish disposed on the fiberfill; and
b) a second fiberfill at least partially coated with a polymeric treatment, wherein the polymeric treatment comprises at least one silicone compound disposed on the fiberfill.

20. The article of claim 10, wherein the article is chosen from finished bedding products, furniture components, stuffing for toys, sleeping bags and animal blankets.

21. The article of claim 20, wherein the finished bedding products are chosen from pillows, mattress pads, comforters, duvets and quilts.

22. A method of measuring a cooling effect of fiberfill in an article, comprising:
a) measuring an initial temperature of the surface of the article at a first region using an infrared imaging device.
b) placing a droplet of water on the surface of the article at the first region; and
c) measuring the temperature at the surface of the article at the first region using an infrared imaging device at multiple time increments after step b is performed.

23. The method of claim 22 further comprising comparing the temperatures measured in step c to the initial temperature measured in step a.

24. The method of claim 22, further comprising at least partially covering the droplet with an infrared transparent cover after placing a droplet of water on the surface of the article at the first region.
